(19) United States
(12) Patent Application Publication
(10) Pub. No.: US 2008/0250374 A1
(43) Pub. Date: Oct. 9, 2008

(54) Method of Making an Integrated Circuit

(75) Inventors: Kevin D. Lucas, Austin, TX (US); Robert E. Boone, Austin, TX (US); Karl Wimmer, Venon (AT); Kyle Patterson, Froges (FR)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 12/067,583

(22) PCT Filed: Sep. 20, 2005
(86) PCT No.: PCT/EP2005/011643

§ 371 Date: Mar. 20, 2008

(51) Int. Cl. G06F 17/50

(52) U.S. Cl. 716/9

(57) ABSTRACT

A method is provided for making an integrated circuit. Cell representing a layout of a set of features, is divided into at least a first region and a second region. Optical Proximity Correction is carried out on at least the first region of cell. One or more instances of cell are located to define IC prior to carrying out final OPC optimisation on the second regions of each cell in the defined IC.

### FIELD OF THE INVENTION

The present invention relates to a method of making an integrated circuit.

### BACKGROUND OF THE INVENTION

When making an integrated circuit (which may also be referred to as a chip or device), photolithography is used to transfer features from a reticle or mask to a semiconductor wafer. Since photolithography is typically not able to faithfully reproduce the reticle design on the wafer, the reticle design is adjusted or optimised so that the features on the semiconductor wafer are created at the desired dimensions. To determine and form the optimised reticle design, the area around a feature on the reticle design must be considered. Techniques such as optical proximity correction (OPC) may be used. The OPC procedure is used to compensate for such optical effects as diffraction, for instance. Such effects may lead to rounded corners of features on the final silicon wafer, or to a reduction in gaps between adjacent features which are outside of process tolerances. The optical influence that features have on their neighbours falls off rapidly as the distance between the features increases. For features on the final chip that are apart by more than several wavelengths of the light used to form the image on the silicon wafer, the influence may be disregarded. This corresponds to a separation of features greater than approximately 1 to 3 μm for ultraviolet light.

The OPC procedure is usually carried out after the design and layout of the integrated circuit has been determined and so is carried out as one of the final steps before the reticle is produced. The OPC procedure is typically carried out using a powerful computer system. Execution times range from several hours to several days depending on the size of the design and the computing power available.

The OPC stage may include a rule based procedure, for instance. Such rules may enlarge the ends of tracks to form hammerheads and extend the outer portions of corners whilst reducing the inner portions, for instance. Model based techniques may also follow. These simulate the resultant optical image formed by the reticle exposure onto the silicon wafer and iteratively correct any abnormal features. Normally, several iterations of OPC calculations are required in order to sufficiently optimise a reticle design, i.e. such that features on the semiconductor wafer are created at the correct dimensions.

As the OPC procedure must be carried out at the end of the design stage, the computer runtime used to perform it adds to the overall delivery time of the final integrated circuit. As the need to increase the number of features on an integrated circuit grows, so too will the OPC calculation runtime. Similarly, as the feature size on integrated circuits decrease, higher tolerances will be required to ensure reliability of the resultant devices. The execution runtime problem will continue to get worse as OPC calculations must be carried out on current computers, which must be used to optimise tomorrow's processors.

In order to improve the integrated circuit design process repeated features such as those forming memory or logic blocks, for instance, are grouped together in cells. This allows designers to reuse previous designs and fragments of designs. In this way, pallets of cells may form large libraries to be incorporated within future integrated circuits.

Several approaches have been tried to minimize the runtime of the final OPC calculation step:

U.S. Pat. No. 6,807,663 describes the use of OPC pre-processing to speed up the final OPC calculation procedure. Repeating structures are found representing cells or parts of cells. OPC calculations are carried out on these repeating structures individually. This is performed before the final chip layout has been constructed. Each cell contains a core surrounded by an empty border region which has a width equal to the proximity range (the distance within which neighbouring features will interfere optically). Cell cores therefore, have a border of dead space around them so that once OPC calculations have been carried out on a cell, such OPC calculations do not need to be repeated once the cell is incorporated into a chip design. In other words, the OPC result for a cell in isolation will be the same at that for a cell located within the integrated circuit. This approach has the drawback that empty space that could otherwise be used for more features is wasted on each chip layer.

Similarly, U.S. Pat. No. 5,682,323 also uses a large library of cells that have already had OPC calculations carried out on them. These cells are placed within the chip design and are each surrounded by empty space so that no proximity affects occur. This has the same drawbacks as those mentioned above.

U.S. Pat. No. 6,425,117 also teaches the method of carrying out OPC calculations on individual cells within a library. These cells are then placed within the integrated circuit design no closer than a minimum distance to ensure that no proximity effects will occur between elements already optimised and corrected. Features on the chip that fall outside of the cell boundaries have additional OPC calculations carried out on them. Again, this leads to wasted space on the chip design.

U.S. Pat. No. 6,194,252 describes the method of carrying out OPC calculations on individual cells before placement in the integrated circuit design. However, when carrying out these pre-calculations dummy features are placed around each cell. This attempts to simulate the environment once the cell is placed within the integrated circuit. This technique has the drawback that the resultant corrections are only estimations as the dummy features will not be the same as the real neighbouring features on the final chip layout. This can lead to errors in the final OPC result and even faults on the device.

It is therefore desirable to provide a method for making an integrated circuit that enables OPC optimisation to be performed with increased accuracy early in the design process.

### SUMMARY OF THE INVENTION

In accordance with a first aspect of the invention, there is provided a method of making an integrated circuit as recited in claim 1 of the accompanying claims. The advantage of this method is to maximise the amount of OPC optimisation carried out on portions of the integrated circuit early on in the design process. This has the benefit of decreasing the time taken to perform the final OPC optimisation step on the completed integrated circuit layout.

Optionally, method step (b) may further comprise the step of: (iii) determining a quantity of additional OPC calculations that will be required for each of the first region and the second region of the cell after the cell is incorporated into the integrated circuit, and wherein the quantity of OPC calculations performed in step (d) is the quantity of additional OPC calculations determined in step (iii). This allows the amount of additional OPC calculations required, to be known when the final OPC run is performed.

Preferably, the quantity of additional OPC calculations found in step (iii) of the method for the first region is zero. This allows full OPC optimisation to be carried out on the first region of each cell and so further reduces the time taken to perform the final OPC optimisation step on the completed integrated circuit layout.

Preferably, determining the quantity of additional OPC calculations depends on the distance between at least one of the first region and the second region and an edge of the cell. This enables multiple regions to be defined in excess of the first and second regions, each requiring a different amount of OPC optimisation to be carried out on the features contained within them. Regions located closer to the edge of the cell (outer regions) will require more OPC optimisation during the final OPC run, as the features contained within the outer regions will be influenced more by features surrounding the cell. It is therefore, not necessary to carry out many OPC iterations on the outer regions when the cell is optimised in isolation.

Advantageously, the amount of additional OPC calculations that will be required for the first region and the second region is a number of OPC iterations. This enables the number of additional OPC iterations required by each region of the cell to be defined and stored within a library of cells.

Advantageously, the second region extends a predetermined distance from an edge of the at least one cell. This allows the cell to be divided into separate regions automatically.

Preferably, the second region surrounds the first region. This simplifies the division of the cell.

Optionally, step (ii) may include performing OPC calculations on all regions of the cell. This simplifies the OPC optimisation carried out on the cell in isolation and allows the cell to be divided into regions after the cell has been optimised.

Advantageously, the method may further comprise the step of: (d) adding the cell (200) to a library of cells. This allows reuse of cells within current and future integrated circuits.

Optionally, step (b) may further comprise the step of: (iv) distinguishing the first region from the second region using one of a marker layer, an edge tag and a feature property. This enables the physical extent of the first and second regions to be recorded.

Optionally, the method may further comprise the step of calculating an expected OPC execution time prior to step (d). This allows the designer to allocated sufficient computing resources to complete the OPC optimisation.

Optionally, the method may further comprise the step of identifying those features which require fewer OPC calculations and locating them remote from the first region. This further reduces the final OPC optimisation runtime as features requiring more OPC optimisation may be located preferentially within the first region, which is optimised at the cell optimisation step.

Optionally, the library of cells may contain cells that have features that require fewer OPC calculations preferentially arranged closer to an edge of the cell than features that require more OPC calculations. This further reduces the final OPC optimisation runtime as features requiring more OPC optimisation may be located preferentially within the first region, which is optimised at the cell optimisation step.

Optionally, method step (b) may further comprise the step of (v) identifying any errors in the integrated circuit. As OPC optimisation is carried out at the cell level any errors may be identified during this early stage and before the final OPC run.

Optionally, the errors found may include any of OPC errors and critical dimension variation errors. OPC errors include forming gaps or connections on the resultant device that are too small to manufacture reliably. Critical dimension variation errors include systematic differences in critical dimension of features occurring across the device due to optical effects of the reticle exposure, for instance.

Optionally, step (b) may further comprise the step: (vi) performing OPC calculations on the second region. This allows partial or full OPC optimisation to be carried out on the entire cell including the first and second regions and any further regions defined. This further reduces the time required for performing the final OPC optimisation carried out on the entire integrated circuit. The amount of OPC optimisation carried out during this step may be limited to some extent or carried out in full. Any such limits may be predetermined. A different amount of OPC optimisation may be carried out on the first and second regions respectively, during this step. Typically, more iterations of OPC optimisation may be required for the first region than for the second region during this step as the first region may not be optimised at all during subsequent final OPC optimisation or may only be optimised by a small amount.

Optionally, the method may further comprise the step: performing OPC calculations on the first region of the or each cell in the defined integrated circuit after step (c). The first region may require further OPC fine tuning once the cell has been placed in the integrated circuit. Such fine tuning may be carried out in this step. This step may be carried out before or after step (d). A different amount of OPC optimisation may be carried out on the first and second regions respectively, during the final OPC optimisation step.

Optionally, the first region may be a central region and the second region may be peripheral region.

Optionally, the first region may be described as a low sensitivity region, whereby features located within this first region may not be sensitive to optical effects due to the distance of this region from areas on the integrated circuit outside of the cell. The low sensitivity region will be surrounded by or be close to areas on the cell or integrated circuit that will not change significantly following placement of the cell within the integrated circuit layout.

Optionally, the second region may be described as a high sensitivity region, whereby features located within this second region may be sensitive to optical effects due to its proximity with areas on the integrated circuit that are likely to change significantly.

The first region of the cell and the second region of the cell contain features. These features are part of the cell.

### BRIEF DESCRIPTION OF THE FIGURES

The present invention may be put into practice in a number of ways and a preferred embodiment will now be described by way of example only and with reference to the accompanying drawings, in which:

FIG. 1 shows a flow diagram of a method for making an integrated circuit in accordance with the present invention, including the steps for designing a cell;

FIG. 2 shows a schematic diagram of the cell used in the method shown in FIG. 1, including a high sensitivity region; and

FIG. 3 shows a schematic diagram of a portion of the integrated circuit used in the method shown in of FIG. 1 including more than one cell.

It should be noted that the figures are illustrated for simplicity and are not necessarily drawn to scale.

### DETAILED DESCRIPTION OF A PREFERRED EMBODIMENT

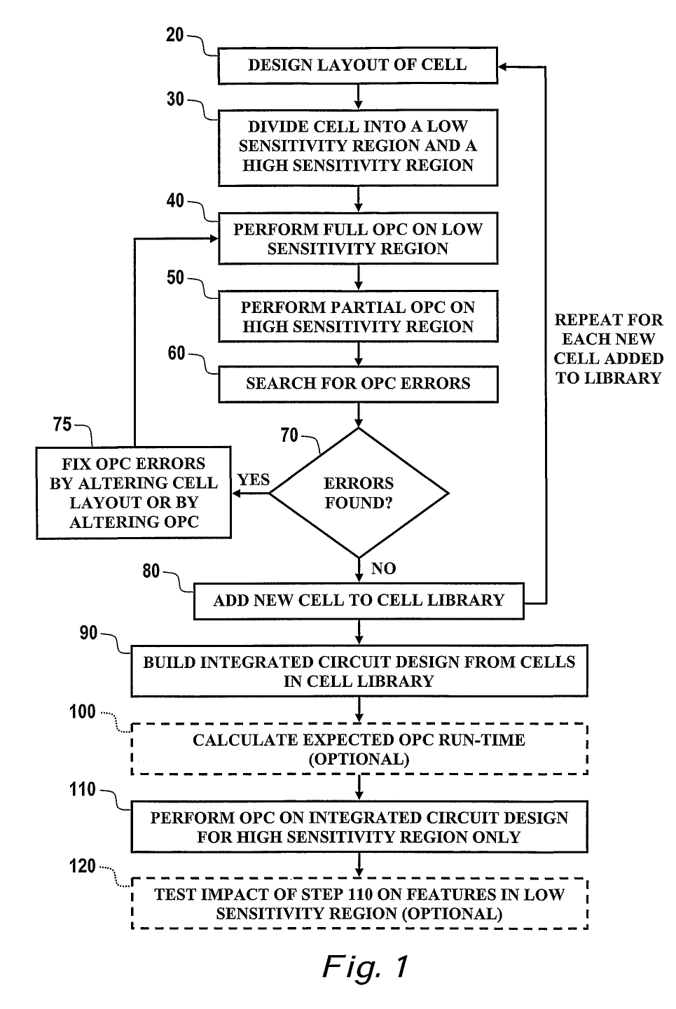

FIG. 1 shows a flow chart describing a method for making an integrated circuit according to one aspect of the present invention. The flow chart does not show all of the steps for making an integrated circuit but these remaining steps will be familiar to the skilled person. The process starts with the design of a layout of a cell, step 20. Each cell represents a layout of a set of features to be incorporated in an integrated circuit, e.g. gates of memory cells. Cells are portions of the integrated circuit which may be repeated many times within the final design. For instance, memory cells or core cells may be used many thousands of times within a particular integrated circuit. Once the layout of the cell has been finalised, it may be easily duplicated within the integrated circuit. Next at step 30, the cell is divided into a low sensitivity region and a high sensitivity region. Features within the low sensitivity region will be far enough from the edge of the cell to ensure that any optical interaction between these features and features of neighbouring cells can be ignored, i.e. outside of the proximity distance. The low sensitivity region contains features that have a low sensitivity, with regard to optical effects, to features placed around the cell. This may be because of the distance between the low sensitivity region and the features around the cell or that the features within the low sensitivity region have physical attributes that reduce the impact of any optical effects. For instance, the features may be large in comparison to neighbouring features. Specifically, these features may be large interconnect features, for instance. However, other features of the cell may be located within the high sensitivity region. The high sensitivity region will contain features that are highly sensitive to features placed around the cell. The reason for this high sensitivity may be because of the proximity of the high sensitivity region to the features around the cell (which may be immediately adjacent to them) or that the features within the high sensitivity region contain structures that are sensitive to optical effects and which, therefore, require higher OPC accuracy.

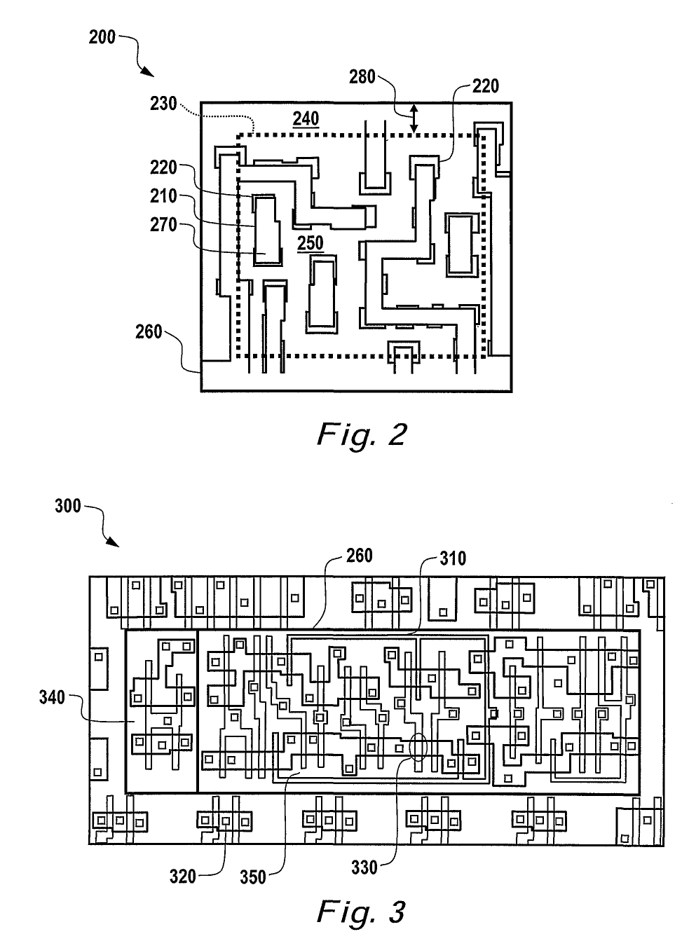

Features within the high sensitivity region of the cell may be affected optically by features of neighbouring cells or other features on the integrated circuit. The structure of a cell and the shape and size of the low sensitivity and high sensitivity regions will be discussed with reference to FIG. 2.

Next at step 40, OPC calculations may be carried but by an OPC tool operating on a computer, to fully optimise the features of the low sensitivity region of the cell. Such OPC tools, for example Proteus (RTM) supported by Synopsys (RTM), inc. of Mountain View, Calif., USA, are familiar to the skilled person and so do not require any further comment. This may require several iterations of calculations until a design is achieved that contains features that are of suitable dimensions. As the low sensitivity region is located far enough from the edge of the cell for its features to avoid any interactions with neighbouring cells or other features outside of the cell itself, the low sensitivity region of the cell will not require any further OPC calculations once the cell has been placed within the chip design. The features within the low sensitivity regions will be optically affected by features within the high sensitivity region of the cell (if there are any present) but these interactions will be fully considered during the initial OPC optimisation step carried out on the cell in isolation (step 40).

Next at step 50, partial OPC calculations are carried out on the high sensitivity region. Because the features located in the high sensitivity region may be affected by other as yet unknown, bordering features or other cells, it is not possible to obtain full OPC results for this region at this stage. Therefore, it is not necessary to fully optimise the features within the high sensitivity region (this will need to be repeated once the cell is incorporated in the layout of the device, in any case). Whilst carrying out OPC calculations, errors in the design may be found by the OPC tool or other software. Such errors that may be identified may include features that are too close together or features that do not overlap enough (e.g. gates and contacts). The next step is, therefore, to search for any errors, step 60. If errors are detected, step 70, they are fixed, step 75, and the layout of the cell may change or the OPC process may be adjusted and further OPC calculations may be required on the cell. Therefore, steps 40 to 70 will need to be repeated until no errors are found.

Once a cell layout has been finalised and all necessary OPC calculations have been carried out, the data describing the physical properties of the cell, including the geometries of all of the features and segments (portions added to the features during OPC processing), may be added to a library of other finalised cells, step 80. The library forms a pallet of cells that a designer may use to build the integrated circuit layout.

Once the designer has designed the full integrated circuit using cells from the library (step 90) as well as other necessary features such as connectors, it will be possible to estimate the total runtime necessary for the final OPC execution. Such a final OPC run is necessary to optimise all of the features within each cell high sensitivity region and any other features not already optimised (this should not be required for any low sensitivity region on any cell). The calculation of estimated OPC runtime step 100 is optional but will be of use to the designer when allocating necessary computing resources as well as providing an indication of the delivery time of the final integrated circuit. With prior art methods, it is difficult to obtain an accurate estimate of runtime as many calculations within the final OPC step 110 are required. However, as many of the OPC calculations have already been finalised, the present invention provides a more accurate estimate of final OPC runtime. A further step, 120, may optionally be carried out that tests the effect of the OPC optimisation on the high sensitivity regions on the low sensitivity regions. This step may be required due to physical changes made to the high sensitivity regions during OPC optimisation. Although these changes may be small they may effect the features of the low sensitivity regions, which were optimised when the high sensitivity regions had slightly different layouts.

FIG. 2 shows a schematic diagram for an example cell 200. The cell 200 has a low sensitivity region 250 and a high sensitivity region 240 and the cell has an edge 260. The cell contains several features of which feature 270 is an example. Feature 270 has a border 210 showing the original extent of feature 270 prior to any OPC optimisation. Feature 270 also has a corrected border 220 showing the extent of the feature 270 after OPC calculations have been completed. Corrected border 220 includes additional segments added during OPC optimisation.

In FIG. 2, the cell 200 is substantially square but can be any shape including rectangular, oval or circular. The low sensitivity region 250 is surrounded by the high sensitivity region 240. The width 280 of the high sensitivity region 240 is determined by the distance within which features interfere with each other optically, i.e. the proximity distance. This distance may be determined experimentally, calculated or observed from carrying out repeated OPC calculations.

Any features 270 within the low sensitivity region 250 will have full OPC optimisation carried out on them before adding the cell 200 to the cell library. Any features within the high sensitivity region 240 may have none or some OPC calculations carried out on them during the partial OPC step 50. The layout of the cell together with the details of any changes made during OPC optimisation is stored in any suitable file format within the cell library. These file formats may include the GDS-II format.

FIG. 3 shows a schematic diagram of a portion of an integrated circuit 300. This portion 300 includes two cells 340 and 350. Various features are shown including metallic contacts 320, overlapping portions 330 forming gate electrodes and connection tracks 310.

When performing OPC optimisation the feature type may be considered by the OPC tool in order to determine the amount and/or type of OPC optimisation to be carried out. For instance, a device may tolerate more physical distortion to connection tracks 310 and so these features will require less OPC optimisation. Conversely, overlapping features 330 such as gate electrodes or metallic connections 320 will have a minimum critical dimension (CD) that must be met to ensure proper function. These types of features require finer tolerances to ensure proper overlap, which in turn require more OPC optimisation or iterations to be performed. Such features are known as critical regions. The final OPC step 110 runtime can be minimised by maximising the amount of OPC optimisation carried out before the cell is added to the library 80. Therefore, carrying out full OPC optimisation of features requiring finer tolerances during step 40 (full OPC optimisation on the low sensitivity region of the cell) will further decrease final OPC runtime.

In order to achieve this reduction in final OPC runtime, a further embodiment of the present invention involves locating cell 350 components requiring less OPC optimisation, such as connection tracks 310, for instance, within the high sensitivity region 240, where possible, and locating features requiring more OPC optimisation within the low sensitivity region 250. Obviously, this may only be achieved where physical constraints can be met. This is an additional design constraint that may be implemented manually by the designer when building the layout of a cell or may be performed automatically by a design aid such as a computer aided design program. The effect of this additional design constraint is that a higher proportion of full OPC optimisation is carried out (all features located within the low sensitivity region 250 will undergo full OPC optimisation) on features requiring finer tolerances.

As will be appreciated by the skilled person, details of the above embodiment may be varied without departing from the scope of the present invention, as defined by the appended claims.

For example, any lithographic technique may be employed including ultraviolet, deep ultraviolet, extreme ultraviolet, X-ray and electron projection lithography. The cell may be divided into more than two regions. This could include 3, 4, 5 or more concentric regions. Also, the regions need not be concentric and may include other layouts such as separate islands within each cell of different shapes such as squares, rectangles or circles.

As an alternative, step 50 of the method (partial OPC on high sensitivity region) may be removed as OPC optimisation is carried out on the high sensitivity regions of all cells (step 110) once the integrated circuit layout has been finalised (step 90).

1. A method of making an integrated circuit comprising the steps of:
(a) providing a cell representing a layout of a set of features to be incorporated into an integrated circuit;
(b) performing optical proximity correction calculations on the cell comprising the following steps:
(i) dividing the cell into a first region and a second region
(ii) performing OPC calculations on at least the first region, and
(iii) determining a quantity of additional OPC calculations that will be required for each of the first region and the second region of the cell after the cell is incorporated into the integrated circuit;
(c) locating one or more instances of the cell to define the integrated circuit; and
(d) performing the quantity of OPC calculations determined in step (iii) on the second region of the or each cell in the defined integrated circuit.

2. The method of claim 1 wherein the quantity of additional OPC calculations found in step (iii) for the first region is zero.

3. The method of claim 1, wherein determining the quantity of additional OPC calculations depends on the distance between at least one of the first region and the second region and an edge of the cell.

4. The method of claim 1, wherein the amount of additional OPC calculations that will be required for the first region and the second region is a number of OPC iterations.

5. The method of claim 1, wherein the second region extends a predetermined distance from an edge of the at least one cell.

6. The method of claim 1, wherein the second region surrounds the first region.

7. The method of claim 1, wherein step (ii) includes performing OPC calculations on all regions of the cell.

8. The method of claim 1, wherein adding the cell to a library of cells.

9. The method of any previous claim 1 wherein step (b) further comprises the step of:
(iv) distinguishing the first region from the second region using one or more of a marker layer, an edge tag and a feature property.

10. The method of claim 1, wherein calculating an expected OPC execution time prior to step (d).

11. The method of any previous claim 1 wherein identifying those features which require fewer OPC calculations and locating them remote from the first region.

12. The method of claim 8 wherein the library of cells contains cells that have features that require fewer OPC calculations preferentially arranged closer to an edge of each cell than features that require more OPC calculations.

13. The method of claim 1, wherein step (b) further comprises the step of:
(v) identifying any errors in the integrated circuit.

14. The method of claim 13, wherein the errors including any of OPC errors and critical dimension variation errors.

15. The method of claim 1, wherein step (b) further comprises the step:
(vi) performing OPC calculations on the second region.

16. The method of claim 1, further comprising the step:
performing OPC calculations on the first region of the or each cell in the defined integrated circuit after step (c).

17.-19. (canceled)

20. An integrated circuit manufactured according to the method of claim 1 further comprising:
manufacturing the integrated circuit.

21. The method of claim 2, wherein determining the quantity of additional OPC calculations depends on the distance between at least one of the first region and the second region and an edge of the cell.

22. The method of claim 2, wherein the amount of additional OPC calculations that will be required for the first region and the second region is a number of OPC iterations.

23. A computer-readable medium comprising instruction whose execution causes the performance of:
(a) performing optical proximity correction calculations on a cell representing a layout of a set of features to be incorporated into an integrated circuit, the performing including the following steps:
(i) dividing the cell into a first region and a second region,
(ii) performing OPC calculations on at least the first region, and
(iii) determining a quantity of additional OPC calculations that will be required for each of the first region and the second region of the cell after the cell is incorporated into the integrated circuit;
(b) locating one or more instances of the cell to define the integrated circuit; and
(c) performing the quantity of OPC calculations determined in step (iii) on the second region of the or each cell in the defined integrated circuit.
